(19) United States
(12) Patent Application Publication
(10) Pub. No.: US 2011/0041382 A1
(43) Pub. Date: Feb. 24, 2011

(54) Fly-safe, fly patch

(76) Inventor: Carl Lance Boling, San Jose, CA (US)

Correspondence Address: Carl Lance Boling, 4615 Royal Grove Ct., San Jose, CA, 95136, US

(21) Appl. No.: 12/806,789

(22) Filed: Aug. 20, 2010

Related U.S. Application Data
(60) Provisional application No. 61/274,796, filed on Aug. 22, 2009.

(51) Int. Cl. A01K 97/06

(52) U.S. Cl. 43/54.1

(57) ABSTRACT

A fly-safe fly patch for containing and drying fishing flies having an outer injection molded cover, an inner injection molded telescoping capsule, and a gate when actuated provides access to an internal storage chamber within the fly patch's capsule. The fly patch is sized such that the fly patch may be actuated with a single hand, the thumb and forefingers. The fly patch is constructed such that the described means for actuating exposes a gate in the sidewall accessing the inner storage chamber and when manual compression is removed the gate in the sidewall automatically shuts providing a safe, loss free environment for the fishing flies. The fly patch is shaped to avoid entanglement with brush and other accessories used during angling as well as include a fixation apparatus for attaching the fly-patch to a fly-fishing vest or other articles during angling.

### CROSS REFERENCE TO RELATED APPLICATIONS

This application claims the benefit under 35 U.S.C. 119 of US Provisional Patent Application No. 61/274,796 filed Apr. 22, 2009, titled “FLY-SAFE FLY PATCH”. This application is herein incorporated by reference in their entirety.

### FIELD OF THE INVENTION

This invention relates to fly-fishing accessories in particular, a fly patch, an apparatus used during fly-fishing, for containing and drying fishing flies.

### BACKGROUND

The typical angler may fish several miles of river, streams, and lakesides over the course of the usual fishing day, frequently entering and exit the water's edge as they probe pools and riffles in search for their quarry. Fish that are generally preferred by fly anglers thrive in cooler water shaded by brush thickets, trees, and other dense forms of riparian flora, which keeps the water cool but also creates a formidable barrier for angler to penetrate as they stalk fish.

While in the course of fly-fishing, anglers may exchange their flies frequently, up to a dozen changes daily depending on the fishing conditions, the insect population, the time of day, or the mood of the angler. The undesired fly is usually damp from fishing so when the angler removes the undesirable fly is either returned to the originating fly box, the least desirable option because fly boxes are not ventilated and designed to keep streamside moisture from exposing stored flies, or the angler attaches the damp fly to a fly patch. A fly patch is a fly-fishing accessory attached to the lapel, the collar, or a pocket-flap on a fishing vest. The fly patch is the preferred method for temporarily holding and drying damp flies because the fly patch allows air to circulate around the fly promoting evaporation before returning the fishing fly back into the parent fly box at the end of the fishing day. Unfortunately, all contemporary fly patches' have limitations, either by being expensive through the loss of flies or in device cost, inconvenient to use, or in some cases even compromising the angler's safety.

The most widely type of fly patch used is the classic wool fly patch. The patch, constructed from a leather-backed swatch of lamb's fleece several has several distinct disadvantages. While the patch is inexpensive, anglers must attach flies to the fleece by entangling the hook into the wool fibers. As anglers enter and exit the edge-water, the act of bushwhacking through riparian fauna or other waterside obstacles tends to dislodge the flies from the fleece. Fly dislodgement is particularly problematic with when employing barbless-hook fishing practices because barbless fly patterns are more difficult to entangle in the fleece. Losing half-dozen flies a day and over several fishing trips is costly.

Other contemporary fly patches such as those constructed from segments of open face plastic ripple-foam or those constructed using magnets mounted into plastic enclosures are more convenient for attaching the fly but are no more effective for fly retention. Because the fly is exposed to the elements, brush or fly-line easily wipe flies off the ripple-foam and magnetic patches as is synonymous with the wool patch.

The hinged clamshell, box-type fly patch type protects the fly from loss during bushwhacking because the fly resides within the box's enclosure. Although the box-type enclosure protects the flies from inadvertent dislodgement, inserting flies into the box can be difficult particularly when it is cold, when the fly angler is wearing gloves, when the angler is negotiating traitorous edge-water terrain, or when the angler is vicariously wading in swift water. Using the hinged box is cumbersome to close particularly when wading concentration is at a premium. The hinged box-type fly patch requires firm manual manipulation to close and secure the flies within. In addition, the box's shape as well as the method of attaching the box to the fly vest is prone to entanglement or dislodgement while pushing through brush or managing fly-line. Lastly the box-type enclosure is heavier than most other fly-patches currently being marketed including the invention, the fly-safe, fly patch.

The invention, the fly-safe, fly patch provides several improvements over the existing products. The invention, the fly-safe, fly patch is lightweight and compact. The invention is also simple to operate; opening the invention is accomplished with a single hand, using tactile feel, and compressing the invention with ones thumb and forefingers. The invention automatically closes when released which is particularly convenient when cold weather reduces dexterity, when wading in swift rivers.

The invention has a cost savings advantage over other fly patches. The invention does not expose flies to brush or riparian habitat as they are contained within the invention therefore it is impossible to dislodge the contained flies. In addition, the geometric shape of the invention, the fly-safe, fly patch reduces entanglement from fishing linen and other fishing accessories while fishing because the generous contours of the inventions exterior deflects obstacles. Considering the cost of a quality fly, between 1.50 and 4.50 dollars, losing half-dozen flies during the course of the fishing day is relatively expensive. The fly-fishing industry in America and aboard continues to grow year over year with approximately 25 million anglers enjoying the sport worldwide, the accumulative saving from inadvertently lost flies is surmountable.

To reiterate, the greatest advantage of this invention is the simplicity of the fly-safe fly patch, actuates with a single hand and closes automatically. The simplicity not only improves the streamside experience but also reduces the risks associated with negotiating the water. Aside from the safety advantages, this invention is economical to manufacture when injection molded and even with comparing the cost of this invention to a lesser expensive wool or ripple foam patches, the purchase price payback would be just a few fishing trips considering the cost of lost flies.

### SUMMARY OF THE INVENTION

In some embodiments, a fly-safe, fly patch configured for containing and drying fishing flies is provided, comprising: an inner capsule member of a predetermined size and having a first proximal enclosed end, an opposite distal enclosed end, and a window though the sidewall of the capsule member; an outer cover member of predetermined size and having a first proximal enclosed end, a second opened distal end, and a window through the sidewall of the cover member; a means for arranging the inner capsule member within the outer cover member such that the arrangement aligns the member's windows and allows access to the capsule members interior space; a means for disarranging the inner capsule member within the outer cover member such that the disarrangement removes alignment between the member's windows and closes access to the capsule member's interior space; and a means to couple the inner capsule member and the outer cover member such that members reciprocate, opening and closing access to the capsule member's interior space.

In some embodiments, the fly patch further comprises a means to attach the fly patch to an article whereas the means for attaching the fly patch to the article is a protrusion integral to the cover member and the integral protrusion comprises at least one preformed hole whereby the fly patch may be tethered.

In some embodiments, the fly patch further comprises a cover member of a predetermined shape and configuration such that the fly patch is resistant to being entangled in brush.

In some embodiments, the fly patch further comprises the capsule member in which the distal end is hemispherical shaped wherein the hemispherical end is ventilated whereby contents within the capsule can dry.

In some embodiments, the fly patch further comprises a means to arrange the capsule member and cover member's windows by manual compressing the capsule member into the cover member whereby opening access to the capsule member's interior space.

In some embodiments, the fly patch further comprises a return spring is configures such that disarrangement between member's windows is automatic whereby closing access to the capsule member's interior space.

In some embodiments, the fly patch further comprises the cover member with a fixation apparatus fastened to the crown whereby the fly patch may be attached to an article.

### DESCRIPTION OF THE FIGURES

FIG. 1, is an illustration of the fly-safe, fly patch in use by an angler;

FIG. 2, is an isometric exploded view of the fly-safe fly patch;

FIG. 3, is a front view of the fly-safe, fly patch;

FIG. 4, is an axial section view of the fly-safe, fly patch along line 4-4;

FIG. 5 is a radial isometric section view of the fly-safe, fly patch along line 5-5.

### DETAILED DESCRIPTION OF THE INVENTION

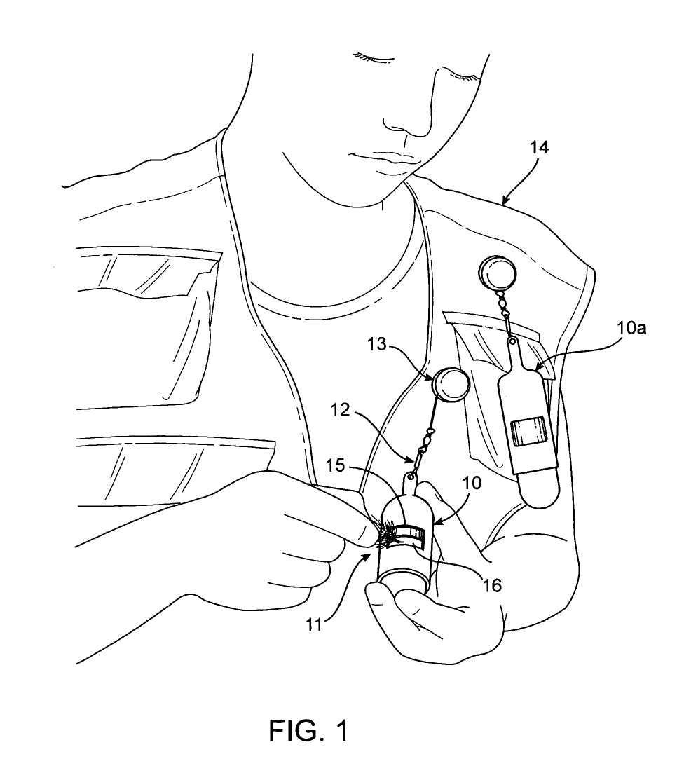

The following description of the invention is not intended to limit the scope of the invention in describing the preferred embodiments but rather to enable any person skilled in the art to make and use this invention. FIG. 1 through 5 illustrates embodiments and use of the invention.

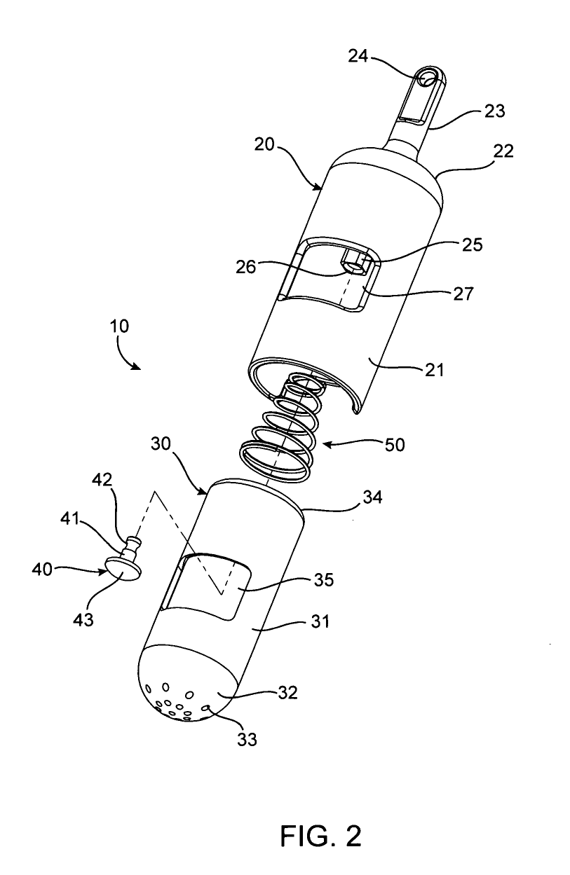

FIG. 1 illustrates an embodiment of the fly-safe, fly patch 10 shown with an angler inserting a fly-fishing lure, or fly 11 through a portal or a gate 15 in the sidewall of the fly patch. In the preferred embodiment, the fly patch is designed to be actuated with a single hand, by manually compressing the fly patch with a thumb and forefingers. Manually compressing the fly provides access through the gate 15 and into an inner storage chamber or compartment 16. The fly patch illustrated is attached to a clasp 12, shown tethering from a commercially available retractor 13. The retractor is one of many common fly-fishing mechanisms designed to provide connectivity between various fly-fishing tools, fishing accessories, and in this embodiment connectivity between the fly patch and a fly-fishing vest 14. After the angler inserts the fly, the angler removes compression from the fly patch and the gate automatically closes. Once closed, a fly patch 10a is shown released and left suspended as where the fly is conveniently and secured stored within the fly patch. The description below in conjunction with FIG. 2 further explains the fly patch's connection method to the retractor.

FIG. 2 illustrates an isometric exploded view of an embodiment of the fly patch 10 comprised of an injection molded opaque plastic, bell-shaped outer shell, or housing, or cover 20 and an inner, injection molded pellucid plastic, tubular shaped container or capsule 30. A stainless steel conical compression spring 50 is captured between the cover and the capsule as the capsule telescopes into the cover. The capsule and spring are connected to cover by an injection-molded plastic, button headed fastener or rivet 40 to be explained further and in detail within the following paragraphs. In this embodiment, the fly patch assembly 10 is approximately 3 cm in diameter and approximately 9 cm in over-all length, however in alternate embodiments; the fly patch may be scaled to accommodate larger or smaller flies or other articles. In addition, in alternate embodiments the fly patch may be constructed square, elliptical, rectangular, or other geometric or abstract sculpted shapes.

In alternate embodiments, the cover 20, capsule 30, and rivet 40 may be constructed in various colors, hues of colors, and in various degrees of opacity ranging from transparent to completely opaque. The cover, capsule, and rivet may be alternately constructed by methods such as casting with thermo-set resins, reaction injection molded using urethane or urethane copolymers, fabricated from composite materials such as carbon, fiberglass or aramid fiber pre-impregnated plastics, compression molding using celluloid or composite cellulose, or machined, deep drawn, or stamped using light-weight aluminum, titanium, or magnesium and their alloys. In alternate embodiments, the method in which the cover is restrained may be accomplished with screws or other common industrial fasteners including spring pins, e-rings, cotter pins, tinner-man's clip, or by plastic fusion or deformation methods such as ultrasonic or thermal welding.

In various alternate embodiments, the fly patch's spring 50 may be constructed from and elastic, a plastic or metal and in the form of either a compression spring, leaf or beam spring or a spring, which is integrated into either the cover or the capsule. Alternately, in other embodiments, the fly patch assembly may be constructed without a spring using the weight of the capsule and gravity to return the fly patch to the uncompressed state.

In one embodiment the cover 20 is comprised of an opened ended thin-walled injection molded cylinder or sleeve 21 approximately 3 cm in diameter and 60 mm in length with the proximal end incorporating an integral domed top or crown 22 approximately the same cross-sectional thickness as the sleeve. The crown incorporates an integral stem 23 approximately 8 mm in diameter and 25 mm long, projecting on-axis from the apex of the crown. The stem includes an aperture, or eye 24 approximately 3 mm in diameter and perpendicular to the stem's axis and located near the distal tip of the stem. The eye 24 is sized to receive the retractor's clasp 12 or other commercially available apparatus used to attach the fly patch to the fishing vest or other articles. In alternate embodiments, the stem 23 may be a separate component constructed to be either insert molded concurrently with the cover, bonded to, or fastened to the crown 22 of the cover. In alternate embodiments, the stem may be excluded completely and a wire-formed clasp or similar standard mechanism might be attached to the crown.

The sidewall 21 of cover 20 incorporates a rectangular opening or window 27 approximately 20 mm wide by 16 mm high and located approximately medial on the cover. A square, integral alignment key-shaft or key 25 approximately 5 mm square and 25 mm in length, projects distally from the internal surface of the crown and towards the open end of the cover. The key includes a circular hole 26 approximately 3 mm and on axis with the key. The hole penetrates into the distal face of the key and sized to receive the rivet shank 41.

In this embodiment, the capsule 30 is comprised of a thin-walled injection molded cylinder 31 incorporating an integral hemispherical basket 32 located at the distal end of the cylinder and a planer flange 34 at the proximal end of the cylinder. The flange is approximately 3 cm in diameter and, approximately 4 mm thick and shown, ultrasonically weld or adhesively bonded enclosing the end of the cylinder's proximal capsule end. The basket includes a plurality of perforations, ventilation holes, or vents 33 of approximately 1 mm in diameter and evenly patterned around and penetrating through the wall of the basket. The vents are sized to promote evaporation between wet flies residing within capsule and the outside environment but sized to prevent fishing flies from accidentally being discharged from the vents in the basket. In alternate embodiments, the vents can be of any predetermined shape, arrangement, and size to facilitate evaporation in combination with fly retention.

The sidewall of the capsule 30 incorporates a rectangular opening or window 35 approximately 20 mm wide by 16 mm high. The window on the capsule sidewall is located such that when the capsule is manually compressed and telescopes into the cover, the cover window 27 aligns with the capsule window 35 forming the gate 15 in the assembled fly patch 10 and providing access to the compartment 16 inside the capsule. In alternate embodiments, the capsule 30 may be segmented or internally divided providing a plurality of compartments assessable through a plurality of windows or openings or gates.

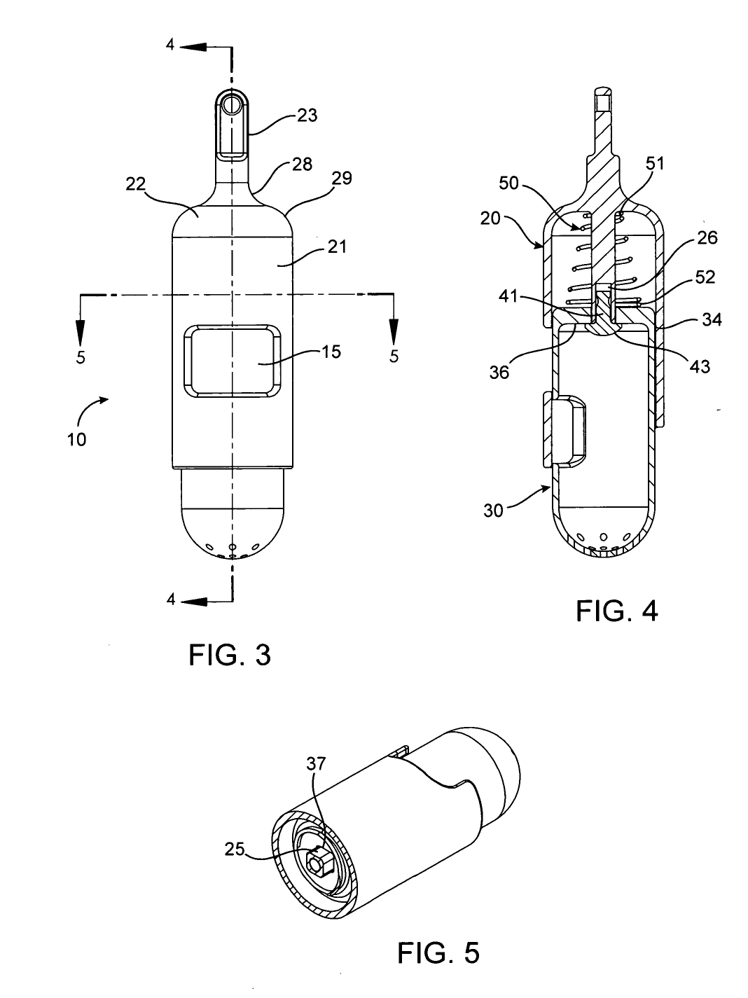

The rivet 40 in this embodiment is comprised of a shank 41 approximately 3 mm in diameter and 7 mm in length. The shank includes a circumferential recess or groove 42 approximately 1 mm wide by 1 mm in depth, sized to accommodate glue or melt flow during assembly. The rivet includes a head 43 approximately 9 mm in diameter and of a predetermined button shape and size. The following paragraphs in conjunction with FIG. 3 through FIG. 5 further describe design and function details of the fly patch.

FIG. 3 illustrates a front view of an embodiment of the fly patch 10 with the gate 15 in the fly patch shown shut with the fly patch residing in an uncompressed state. The fly patch in this embodiment comprises externally contoured surfaces such that abrupt edges are minimize, decreasing the opportunity for entanglement with brush, fishing lines or other articles. The sculpted exterior also serves to enhance ergonomics and ascetics. A concave radius or neck 28 at the base of the stem creates the sweeping intersection point between the stem 23 and crown 22. A convex radius or shoulder 29, the outboard edge of the crown, creates the gradual intersection between the crown and the sleeve 21. The shaped features such as the shoulder 29 and neck 28 reduce fly patch entanglement with the fishing environment.

FIG. 4 is an axial section view of an embodiment along line 4-4 of the fly patch 10 illustrating the spring 50 in communication with the underside of the crown 22 at a proximal spring seat 51 and the spring in communication with the inboard side of the flange 34 at a distal seat 52. The spring 50 is slightly pre-loaded, providing enough compression to keep the gate shut when the fly patch is in the uncompressed state.

The shank 41 of the rivet is a size to fit within the hole 26 and one embodiment adhesive bonded but may also either be pressed fit, screwed, or ultrasonically welded into the hole. The head 43 of the rivet is a predetermined size such the rivet restrains the capsule with head of the rivet in communication with an underside face 36 of the flange 34; retaining the capsule 30 within the cover 20 such that the cover and capsule remain in communication but the capsule remains mobile, able to reciprocate within the cover.

FIG. 5 illustrates a radial isometric section view along line 5-5, of one embodiment of the fly patch. To maintain radial alignment between the cover window and the capsule window, a keyhole 37 within the flange aligns around the key 25. The keyhole and key in this embodiment are approximately 6 mm×6 mm square, and the fit between the key and keyhole is of a predetermined but of a sufficient gap between keyhole and the key to allow the capsule to move freely on axis but restrictive such that rotation positioning between the capsule and cover is limited. In alternate embodiments, other keying features such as, elliptical shaped keys and keyholes, a spline, or other similar keying shapes may also accomplish radial window alignment.

The use of the fly patch 10 shall not be limited to containing flies but in additional embodiments used for many other storage and dispensing applications within and outside the fly-fishing industry. Applications for the fly patch might include containing, storing, and dispensing: fishing indicators, fishing hooks, fishing weights, small fishing accessories, craft supplies such as beads, safety pins, buttons, within the food industry containing items such as hard candies, gum, jelly beans, alternately containing odds and ends, small change, hardware, nut, bolts, and washers. In the alternate uses described, the stem 23, the vents 33, or other features may exclude such that the fly patch may accommodate the alternate containing, storage, and dispensing uses.

As for additional details pertinent to the present invention, materials and manufacturing techniques may be employed as within the level of those with skill in the relevant art. The same may hold true with respect to method-based aspects of the invention in terms of additional acts commonly or logically employed. In addition, it is considered that any optional feature of the inventive variations described may be set forth and claimed independently, or in combination with any one or more of the features described herein. Likewise, reference to a singular item, includes the possibility that there are plural of the same items present. More specifically, as used herein and in the appended claims, the singular forms “a,” “and,” “the,” and “said” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. Unless defined otherwise herein, all technical terms used herein have the same meaning as commonly understood by one of ordinary skill in the art to which this invention belongs. The breadth of the present invention is not to be limited by, the subject specification, but rather only by the plain meaning of the claim terms, employed.

What is claimed is:

1. A fly-safe, fly patch configured for containing and drying fishing flies, comprising:
an inner capsule member of a predetermined size and having a first proximal enclosed end, an opposite distal enclosed end, and a window though the sidewall of the capsule member;
an outer cover member of predetermined size and having a first proximal enclosed end, a second opened distal end, and a window through the sidewall of the cover member;
a means for arranging the inner capsule member within the outer cover member such that the arrangement aligns the member's windows and allows access to the capsule members interior space;
a means for disarranging the inner capsule member within the outer cover member such that the disarrangement removes alignment between the members windows and closes access to the capsule member's interior space; and
a means to couple the inner capsule member and the outer cover member such that members reciprocate, opening and closing access to the capsule member's interior space.

2. The fly patch of claim 1 further comprising a means to attach the fly patch to an article.

3. The fly patch of claim 2 whereas the means for attaching the fly patch to the article is a protrusion integral to the cover member.

4. The fly patch of Claim 3 wherein the integral protrusion comprises at least one preformed hole whereby the fly patch may be tethered.

5. The fly patch of claim 1 further comprising a cover member of a predetermined shape and configuration such that the fly patch is resistant to being entangled in brush.

6. The fly patch of claim 1 further comprising the capsule member in which the distal end is hemispherical shaped.

7. The fly patch of claim 6 wherein the hemispherical end is ventilated whereby contents within the capsule can dry.

8. The fly patch of claim 1 further comprising a means to arrange the capsule member and cover member's windows by manual compressing the capsule member into the cover member whereby opening access to the capsule member's interior space.

9. The fly patch of claim 1 further comprising a return spring is configures such that disarrangement between member's windows is automatic whereby closing access to the capsule member's interior space.

10. A fly-safe, fly patch configured for containing articles:
an inner cylindrical capsule member of a predetermined size and having a first proximal enclosed end, an opposite distal enclosed end, and a window though the sidewall of the capsule member;
an outer cylindrical cover member of predetermined size and having a first proximal enclosed end, a second opened distal end, and a window through the sidewall of the cover member;
a means for arranging the inner capsule member within the outer cover member such that the arrangement aligns the member's windows and allows access to the capsule members interior space;
a means for disarranging the inner capsule member within the outer cover member such that the disarrangement removes alignment between the member's windows and closes access to the capsule member's interior space; and
a means to couple the inner capsule member and the outer cover member such that members reciprocate, opening and closing access to the capsule member's interior space.

11. The fly patch of claim 10 further comprising the cover member with a fastened fixation apparatus whereby the fly patch may be attached to an article.

12. The fly patch of claim 10 further comprising a means to arrange the capsule member and cover member's windows by manual compressing the capsule member into the cover member whereby opening access to the capsule member's interior space

13. The fly patch of claim 10 further comprising a return spring whereby disarrangement between member's windows is automatic whereby when disarranged the access to the inner capsule space is closed.
